(19) United States
(12) Patent Application Publication
(10) Pub. No.: US 2026/0014043 A1
(43) Pub. Date: Jan. 15, 2026

(54) Muscle Stretching and Massage Rolling Device and Method of Use

(71) Applicant: Sammie Corral, Lovington, NM (US)

(72) Inventor: Sammie Corral, Lovington, NM (US)

(21) Appl. No.: 18/952,243

(22) Filed: Nov. 19, 2024

Related U.S. Application Data
(60) Provisional application No. 63/669,414, filed on Jul. 10, 2024.

(51) Int. Cl. A61H 1/02

(52) U.S. Cl. CPC A61H 1/02; A61H 2201/0107; A61H 2201/0161

(57) ABSTRACT

A muscle stretching and rolling device is disclosed. The device is an improved muscle stretching and rolling device that enables athletes and individuals that work out to stretch and roll their limbs and/or muscles thereover without the assistance of another person. The muscle stretching and rolling device comprises feet components, a rack component, and various rollers. The feet components and rack components are able to fully fold together for storage and are connected and adjustable via a spring pin knob on either side. The rack component features polygonal notches at different heights in which the rollers are placed. The rollers feature polygonal ends to provide a sturdy setup. Thus, once the device is unfolded and locked into place, and a roller(s) is placed in a pair of notches, a user can stretch and roll their limbs and/or muscles thereover.

### CROSS-REFERENCE TO RELATED APPLICATION

The present application claims priority to, and the benefit of, U.S. Provisional Application No. 63/669,414, which was filed on Jul. 10, 2024, and is incorporated herein by reference in its entirety.

### FIELD OF THE INVENTION

The present invention relates generally to the field of muscle stretching and massage rolling devices. More specifically, the present invention relates to a muscle stretching and massage rolling device that individuals can use alone and without the assistance of another individual. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in muscle stretching and massage rolling devices. Generally, it is very important for athletes and individuals that work out to stretch and roll their limbs and/or muscles thereover before and after activity. Attempting to roll muscles without the assistance of another individual can be difficult.

Accordingly, there is a demand for an improved muscle stretching and rolling device that enables users to stretch and roll their limbs and/or muscles thereover before and after activity. More particularly, there is a demand for a muscle stretching and rolling device that provides users with the ability to stretch and toll their calf, tibia, and foot muscles without the help of another individual.

Therefore, there exists a long-felt need in the art for an improved muscle stretching and rolling device. More specifically, there exists a long-felt need in the art for an improved muscle stretching and rolling device wherein individuals can use the device alone and without the assistance of another individual.

The subject matter disclosed and claimed herein, in one embodiment thereof, comprises a muscle stretching and rolling device. The device is an improved muscle stretching and rolling device that enables athletes and individuals that work out to stretch and roll their limbs and/or muscles thereover before and after activity without the assistance of another person. The muscle stretching and rolling device comprises feet components, a rack component, and various rollers. The feet components and rack components are able to fully fold together for storage and are connected and adjustable via a spring pin knob on either side. The rack component features octagonal notches at different heights in which the rollers are placed. The rollers feature octagonal ends to provide a sturdy setup. Thus, once the device is unfolded and locked into place, and a roller(s) is placed in one of the notches, a user can stretch and roll their limbs and/or muscles thereover without assistance.

In this manner, the muscle stretching and rolling device of the present invention accomplishes all of the forgoing objectives and provides users with a device that enables for solitary stretching and rolling of muscles before and after activity.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a muscle stretching and rolling device. The device is an improved muscle stretching and rolling device that enables athletes and individuals that work out to stretch and roll their limbs and/or muscles thereover before and after activity without the assistance of another person. The muscle stretching and rolling device comprises feet components, a rack component, and various rollers. The feet components and rack components are able to fully fold together for storage and are connected and adjustable via a spring pin knob on either side. The rack component features octagonal notches at different heights in which the rollers are placed. The rollers feature octagonal ends to provide a sturdy setup. Thus, once the device is unfolded and locked into place, and a roller(s) is placed in one of the notches, a user can stretch and roll their limbs and/or muscles thereover without assistance.

In one embodiment, the muscle stretching and rolling device of the present invention assists any athlete or individual who exercises. The muscle stretching and rolling device enables users to stretch and roll their limbs and/or muscles thereover before and after exercise. The feet components and rack component of the device fold up to allow for easy storage. The is portable in that it is configured to be easily carried by a person.

In one embodiment, the muscle stretching and rolling device comprises two feet components on each side of the rack component. Generally, the feet components are typically configured in a rectangular shape but can be configured in any suitable shape as is known in the art. The feet components are attached to the rack component via spring pin knobs on each side. The spring pin knobs enable the feet components and rack component to lock in place during storage or use.

In one embodiment, the muscle stretching and rolling device also comprises a rack component. The rack component features octagonal notches at varying heights that hold the roller(s). The octagonal notches match up with the octagonal ends of the rollers. Thus, the rollers are held securely in place to support the weight of various muscles and limbs of the user.

In one embodiment, the muscle stretching and rolling device also comprises a variety of rollers. Typically, the rollers are generally cylindrical in shape, although any suitable shape can be used. The octagonal ends of the rollers match the octagonal notches of the rack component, providing a secure fit.

In one embodiment, the muscle stretching and rolling device in accordance with the present invention can be produced in various colors, designs, patterns, etc., and feature logos, emblems and or designs, such as a distributor requests and/or a user desires.

In one embodiment, the muscle stretching and rolling device is manufactured of a lightweight aluminum, or any other suitable material as is known in the art. Any number of different types of materials can be used to make the muscle stretching and rolling device including but not limited to plastics, metals, etc.

In use, the user unfolds the device and locks it into place via the spring pin knobs. The roller is then placed in a pair of opposing polygonal notches at the desired height. The user can then utilize the device to stretch and roll their limbs and/or muscles thereover without assistance. Thus, the muscle stretching and rolling device makes stretching and rolling muscles much more convenient.

It will also be appreciated that there are a number of additional add-on features that can be incorporated into the device and moreover, the muscle stretching and rolling device can take many different forms as is known in the art.

In yet another embodiment, the muscle stretching and rolling device comprises a plurality of indicia.

In yet another embodiment, a novel method of conveniently stretching and rolling muscles using the device is disclosed. The method includes the steps of providing a muscle stretching and rolling device comprising feet components, a rack component, and rollers. The method also comprises unfolding the feet and rack components of the device and locking them into place via the spring pin knobs. Further, the method comprises placing a roller(s) at the desired height in a pair of opposing polygonal notches. Finally, the method comprises utilizing the device to stretch and roll muscles.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the muscle stretching and rolling device of the present invention in accordance with the disclosed architecture;

FIG. 2 illustrates another perspective view of one embodiment of the muscle stretching and rolling device of the present invention in accordance with the disclosed architecture;

FIG. 3 illustrates another perspective view of one embodiment of the muscle stretching and rolling device of the present invention in accordance with the disclosed architecture;

FIG. 4 illustrates a perspective view of one embodiment of the muscle stretching and rolling device of the present invention showing the feet components and rack component fully folded up in accordance with the disclosed architecture;

FIG. 5 illustrates another perspective view of one embodiment of the muscle stretching and rolling device of the present invention showing the feet components and rack component fully folded up in accordance with the disclosed architecture;

FIGS. 6A, 6B, and 6C illustrate multiple perspective views of one embodiment of the muscle stretching and rolling device of the present invention showing and detailing the device unfolded (6A), in use (6B), and folded (6C) in accordance with the disclosed architecture;

FIG. 7 illustrates an infographic featuring multiple perspective views of one embodiment of the muscle stretching and rolling device of the present invention, further detailing the device in accordance with the disclosed architecture; and

FIG. 8 illustrates a flowchart showing the method of conveniently stretching and rolling muscles without assistance in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved muscle stretching and rolling device. More specifically, there exists a long-felt need in the art for an improved muscle stretching and rolling device wherein individuals can use the device alone and without the assistance of another individual.

The present invention, in one exemplary embodiment, is a novel muscle stretching and rolling device for stretching and rolling various muscles without the assistance of another person. The muscle stretching and rolling device comprises feet components, a rack component, and various rollers. The feet components and rack components are able to fully fold together for storage and are connected and adjustable via a spring pin knob on either side. The rack component features octagonal notches at different heights in which the rollers are placed. The rollers feature octagonal ends to provide a sturdy setup. Thus, once the device is unfolded and locked into place, and a roller(s) is placed in one of the notches, a user can stretch and roll their limbs and/or muscles thereover without assistance. The present invention also includes a novel method of conveniently stretching and rolling muscles using the device. The method includes the steps of providing a muscle stretching and rolling device comprising feet components, a rack component, and rollers. The method also comprises unfolding the feet and rack components of the device and locking them into place via the spring pin knobs. Further, the method comprises placing a roller(s) at the desired height in a pair of opposing polygonal notches. Finally, the method comprises utilizing the device to stretch and roll muscles.

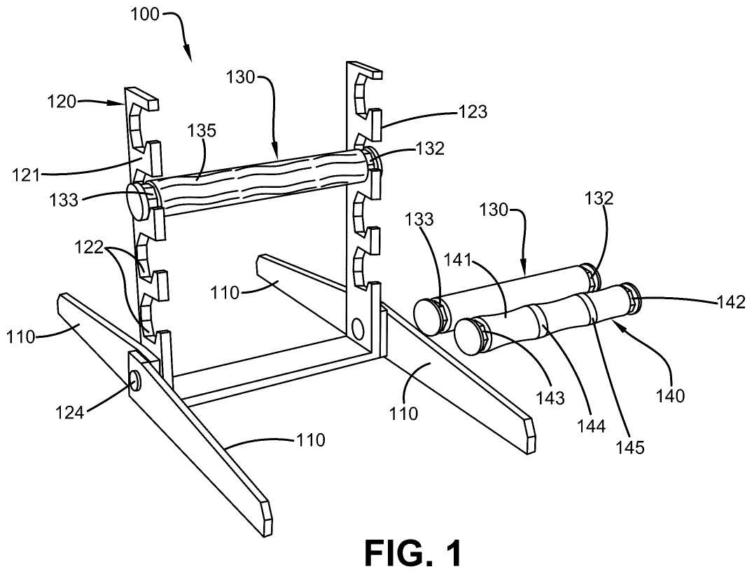

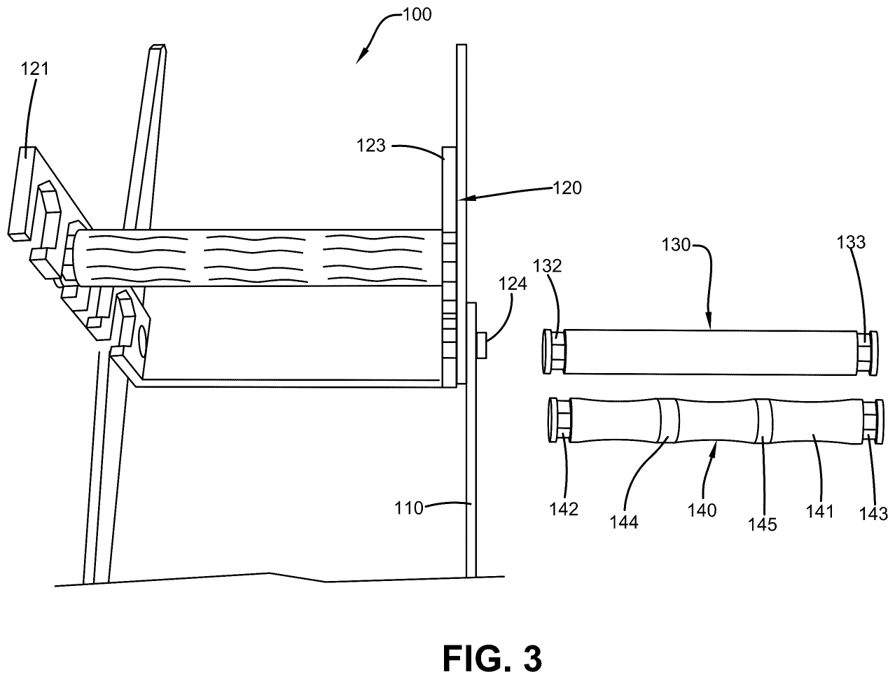

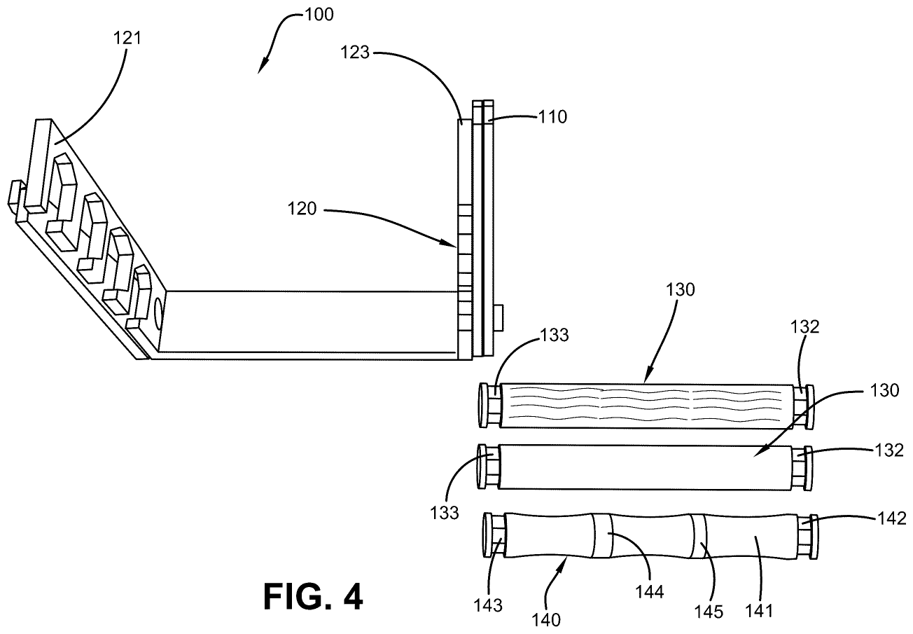

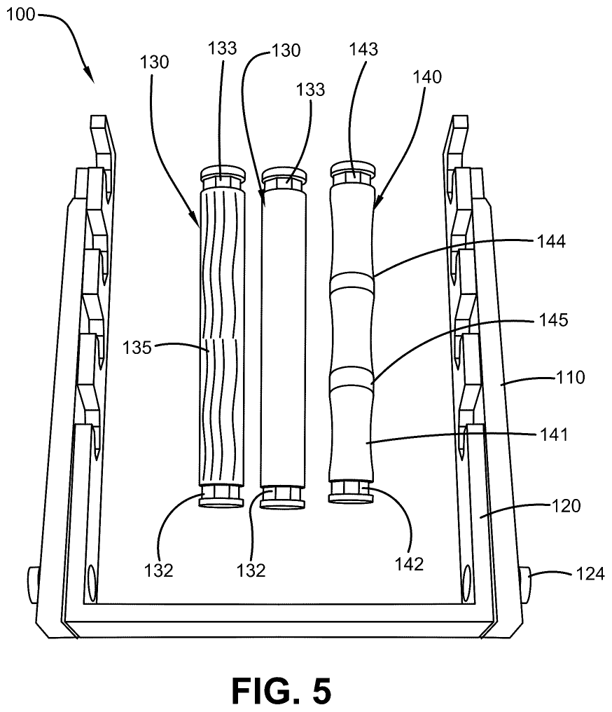

Referring initially to the drawings, FIGS. 1-5 illustrate perspective views of one embodiment of the muscle stretching and rolling device 100 of the present invention. In the present embodiment, the muscle stretching and rolling device 100 is an improved muscle stretching and rolling device 100 that provides a user 300 with a means of stretching and rolling muscles without assistance. Specifically, the muscle stretching and rolling device 100 comprises feet components 110, a rack component 120, opposing rack arms 121, 123, and rollers 130, 140. Thus, once the device 100 is unfolded, a user 300 can place a roller(s) 130, 140 in a pair of opposing polygonal notches and stretch and roll their limbs and/or muscles thereover without the aid of another person.

Generally, the muscle stretching and rolling device 100 of the present invention assists any athlete or individual who exercises. The muscle stretching and rolling device 100 enables users to stretch and roll their limbs and/or muscles thereover before and after exercise. The feet components 110 and rack component 120 of the device 100 fold up to allow for easy storage. The device 100 is portable in that it is configured to be easily carried by a person.

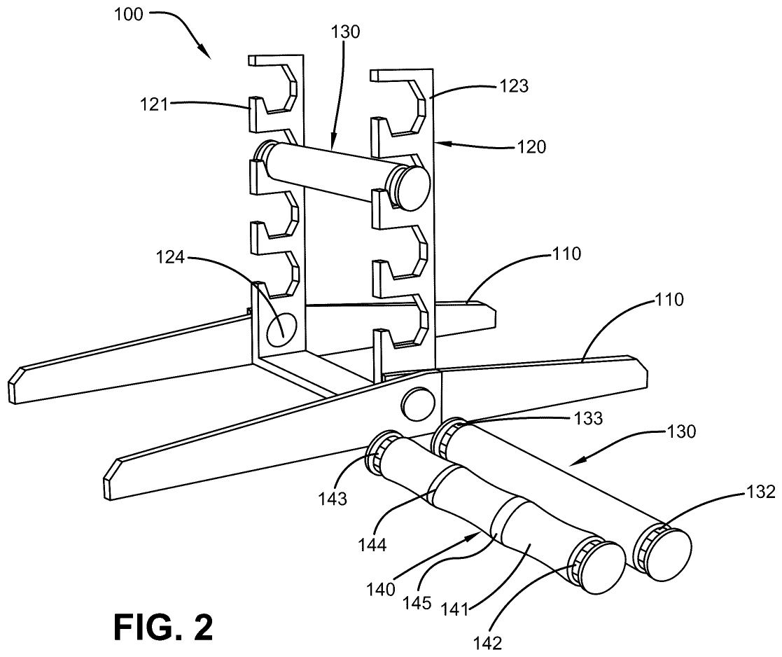

As shown in FIGS. 1-2, the muscle stretching and rolling device 100 comprises two feet components 110 on each side of the rack component 120. Generally, the feet components 110 are typically configured in a rectangular shape but can be configured in any suitable shape as is known in the art. The feet components 110 are attached to the rack component 120 via spring pin knobs 124 on each side. The spring pin knobs 124 enable the feet components 110 and rack component 120, and rack arms 121, 123, to lock in place during storage or use.

As shown in FIGS. 1-2, the muscle stretching and rolling device 100 also comprises a rack component 120. The rack component 120 features a pair of arms 121, 123 including a plurality of opposing pairs of polygonal (i.e., pentagonal, hexagonal, heptagonal, octagonal) notched roller holders 122 at varying heights that selectively hold the roller(s) 130, 140. The plurality of opposing pairs of polygonal (i.e., pentagonal, hexagonal, heptagonal, octagonal) notched roller holders 122 match up with the pentagonal, hexagonal, heptagonal, octagonal, or other polygonal opposing ends 132, 133 and 142, 143 of the rollers 130, 140, respectively. Thus, the rollers 130, 140 are held securely in place to support the weight of various muscles and limbs of the user 300. The rollers 130, 140, while securely held in between the opposing arms 121, 123, are able to spin on internal bearings as the weight of the user's various muscles and limbs are moved thereover.

The muscle stretching and rolling device 100 also comprises a variety of rollers 130, 140. The rollers 130 are generally cylindrical in shape, although any suitable shape or textured outer surface 135 can be used. Roller 140 includes a scalloped outer surface 141 having raised edges 144, 145 along the outer surface 141. The pentagonal, hexagonal, heptagonal, octagonal, or other polygonal opposing ends 132, 133 and 142, 143 of the rollers 130, 140, respectively, match or mate with the plurality of opposing pairs of polygonal notched roller holders 122 of the rack component 120 thereby providing a secure fit.

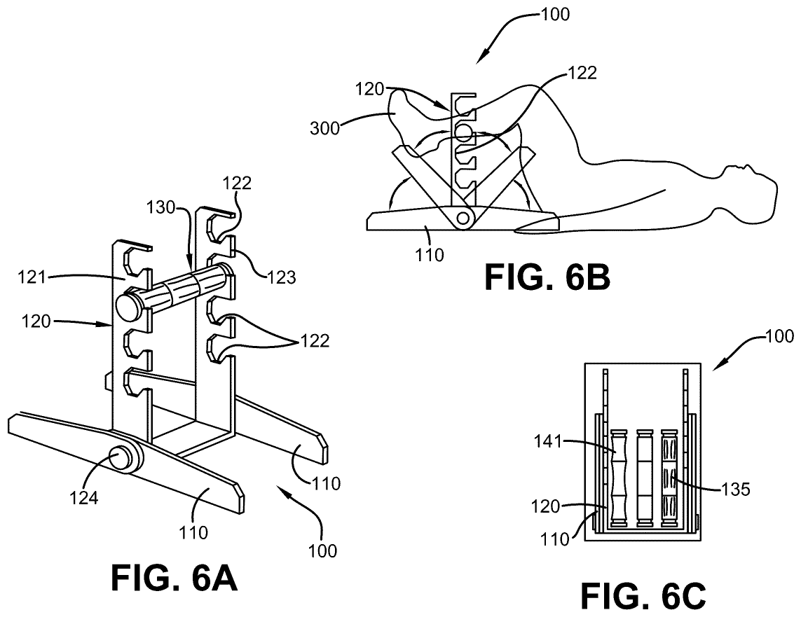

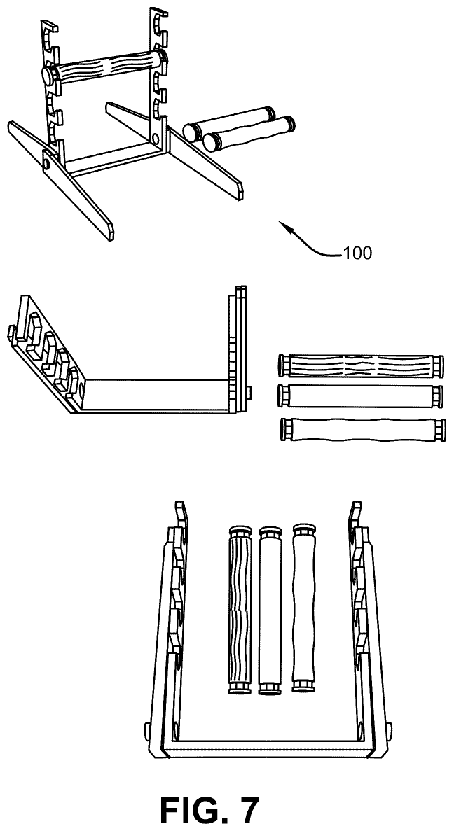

As shown in FIGS. 6A, 6B, 6C and 7, in use, the user 300 starts by unfolding the feet components 110 rack component 120 of the device 100 and locking them into place via the spring pin knobs 124. Next, the user places a roller(s) 130, 140 at the desired height(s) in the polygonal notched roller holders 122 (FIG. 6A). The user 300 utilizes the device 100 to stretch and roll their limbs and/or muscles thereover (FIG. 6B). Finally, the user folds the device 100 for storage and transport (FIG. 6C).

It is to be appreciated that the muscle stretching and rolling device 100 in accordance with the present invention can be produced in various colors, designs, patterns, etc., and feature logos, emblems and or designs, such as a distributor requests and/or a user 300 desires.

In one embodiment, the muscle stretching and rolling device 100 is manufactured of a lightweight aluminum, or any other suitable material as is known in the art. Any number of different types of materials can be used to make the muscle stretching and rolling device 100 including but not limited to other metals, metal alloys, heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc.

In yet another embodiment, the muscle stretching and rolling device 100 comprises a plurality of indicia 400. The feet components 110, rack component 120, or rollers 130, 140 of the device 100 may include advertising, a trademark, or other letters, designs, or characters, printed, painted, stamped, or integrated into the components, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be sports, muscles, or brand related.

It will also be appreciated that there are a number of additional add-on features that can be incorporated into the device 100 and moreover, the muscle stretching and rolling device 100 can take many different forms as is known in the art.

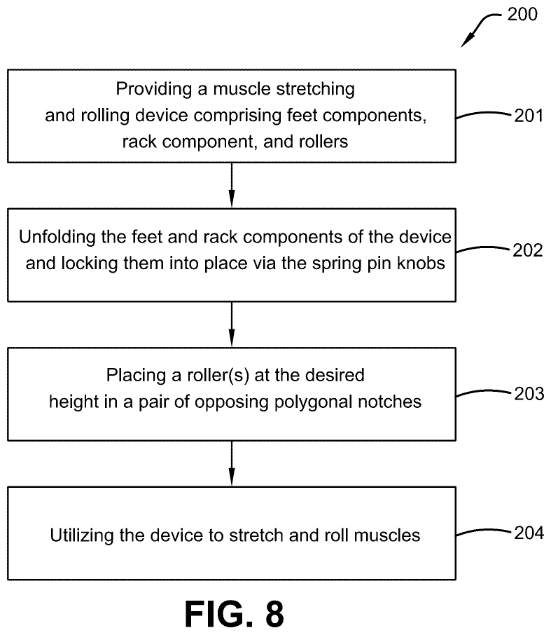

FIG. 8 illustrates a flowchart of the novel method 200 of conveniently stretching and rolling muscles using the device. The method includes the steps of at 201, providing a muscle stretching and rolling device comprising feet components, a rack component, and rollers. The method also comprises at 202, unfolding the feet and rack components of the device and locking them into place via the spring pin knobs. Further, the method comprises at 203, placing a roller(s) at the desired height in a pair of opposing polygonal notches. Finally, the method comprises at 204, utilizing the device to stretch and roll muscles.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “muscle stretching and rolling device”, “stretching and rolling device”, “muscle device”, and “device” are interchangeable and refer to the muscle stretching and rolling device 100 of the present invention.

Notwithstanding the forgoing, the muscle stretching and rolling device 100 of the present invention can be of any suitable size and configuration as is known in the art without affecting the overall concept of the invention, provided that it accomplishes the above stated objectives. One of ordinary skill in the art will appreciate that the muscle stretching and rolling device 100 as shown in FIGS. 1-7 is for illustrative purposes only, and that many other sizes and shapes of the muscle stretching and rolling device 100 are well within the scope of the present disclosure. Although the dimensions of the muscle stretching and rolling device 100 are important design parameters for user convenience, the muscle stretching and rolling device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A muscle stretching and rolling device comprising:
a rack having a plurality of feet and a pair of opposing arms;
a plurality of polygonal roller holders; and
a plurality of rollers;
wherein said pair of opposing arms having said plurality of polygonal roller holders;
wherein said plurality of polygonal roller holders comprising a plurality of opposing pairs of polygonal roller holders;
wherein each pair of said plurality of opposing pairs of polygonal roller holders having a different height; and
further wherein a selected at least one of said plurality of rollers mounted in at least one of said plurality of opposing pairs of polygonal roller holders for moving a user's limb thereover.

2. The muscle stretching and rolling device of claim 1, wherein said plurality of feet and said pair of opposing arms are foldable.

3. The muscle stretching and rolling device of claim 1, wherein a selected at least three of said plurality of rollers mounted in at least three of said plurality of opposing pairs of polygonal roller holders for moving a user's limb thereover.

4. The muscle stretching and rolling device of claim 1, wherein a selected at least four of said plurality of rollers mounted in at least four of said plurality of opposing pairs of polygonal roller holders for moving a user's limb thereover.

5. The muscle stretching and rolling device of claim 1, wherein each of said plurality of rollers having an outer surface selected from the group consisting of a smooth outer surface, a textured outer surface, and a scalloped outer surface.

6. The muscle stretching and rolling device of claim 5, wherein each of said plurality of rollers having opposing polygonal mounting ends for mating with one pair of said plurality of opposing pairs of polygonal roller holders for securing said plurality of rollers between said pair of opposing arms.

7. The muscle stretching and rolling device of claim 6, wherein each of said plurality of rollers having internal bearings for turning said plurality of rollers after securing said plurality of rollers between said pair of opposing arms.

8. The muscle stretching and rolling device of claim 7, wherein each of said plurality of opposing pairs of polygonal roller holders having a shape selected from the group consisting of a pentagon, a hexagon, a heptagon, and an octagon.

9. The muscle stretching and rolling device of claim 8, wherein each of said opposing polygonal mounting ends having a shape selected from the group consisting of a pentagon, a hexagon, a heptagon, and an octagon.

10. A muscle stretching and rolling device comprising:
a rack having a plurality of feet and a pair of opposing arms;
a plurality of polygonal roller holders; and
a plurality of rollers;
wherein said pair of opposing arms having said plurality of polygonal roller holders;
wherein said plurality of polygonal roller holders comprising a plurality of opposing pairs of polygonal roller holders;
wherein each pair of said plurality of opposing pairs of polygonal roller holders having a different height;
wherein a selected at least two of said plurality of rollers mounted in at least two of said plurality of opposing pairs of polygonal roller holders for moving a user's limb thereover; and
further wherein each of said plurality of rollers having opposing polygonal mounting ends for mating with one pair of said plurality of opposing pairs of polygonal roller holders for securing said plurality of rollers between said pair of opposing arms.

11. The muscle stretching and rolling device of claim 10, wherein said plurality of feet and said pair of opposing arms are foldable.

12. The muscle stretching and rolling device of claim 10, wherein a selected at least three of said plurality of rollers mounted in at least three of said plurality of opposing pairs of polygonal roller holders for moving a user's limb thereover.

13. The muscle stretching and rolling device of claim 10, wherein each of said plurality of rollers having an outer surface selected from the group consisting of a smooth outer surface, a textured outer surface, and a scalloped outer surface.

14. The muscle stretching and rolling device of claim 10, wherein each of said plurality of rollers having internal bearings for turning said plurality of rollers after securing said plurality of rollers between said pair of opposing arms.

15. The muscle stretching and rolling device of claim 10, wherein each of said plurality of opposing pairs of polygonal roller holders having a shape selected from the group consisting of a pentagon, a hexagon, a heptagon, and an octagon.

16. The muscle stretching and rolling device of claim 15, wherein each of said opposing polygonal mounting ends having a shape selected from the group consisting of a pentagon, a hexagon, a heptagon, and an octagon.

17. A method of using a muscle stretching and rolling device, the method comprising the steps of:
providing a rack having a plurality of feet and a pair of opposing arms, a plurality of polygonal roller holders, and a plurality of rollers, wherein said pair of opposing arms having said plurality of polygonal roller holders, wherein said plurality of polygonal roller holders comprising a plurality of opposing pairs of polygonal roller holders, further wherein each pair of said plurality of opposing pairs of polygonal roller holders having a different height;
mounting a selected at least one of said plurality of rollers in at least one of said plurality of opposing pairs of polygonal roller holders;
moving a user's limb over said at least one of said plurality of rollers;
mating each of said plurality of rollers with at least one of said plurality of opposing pairs of polygonal roller holders, wherein each of said plurality of rollers having opposing polygonal mounting ends for mating with one pair of said plurality of opposing pairs of polygonal roller holders; and
securing said at least one of said plurality of rollers between said pair of opposing arms.

18. The method of using a muscle stretching and rolling device of claim 17, wherein a selected at least two of said plurality of rollers mounted in at least two of said plurality of opposing pairs of polygonal roller holders for moving a user's limb thereover.

19. The method of using a muscle stretching and rolling device of claim 18, wherein said plurality of feet and said pair of opposing arms are foldable, and further wherein each of said plurality of rollers having an outer surface selected from the group consisting of a smooth outer surface, a textured outer surface, and a scalloped outer surface.

20. The method of using a muscle stretching and rolling device of claim 19, wherein each of said plurality of rollers having internal bearings for turning said plurality of rollers after securing said plurality of rollers between said pair of opposing arms.
